(19) United States
(12) Patent Application Publication
(10) Pub. No.: US 2023/0209359 A1
(43) Pub. Date: Jun. 29, 2023

(54) METHOD AND APPARATUS FOR FLEXIBLY CONSTRUCTING A NETWORK SERVICE

(71) Applicant: Rakuten Mobile, Inc., Tokyo (JP)

(72) Inventors: Abhishek SHARMA, Tokyo (JP); Mohit LUTHRA, Singapore (SG)

(21) Appl. No.: 17/645,951

(22) Filed: Dec. 23, 2021

(51) Int. Cl. H04W 16/10; H04W 48/18; H04W 4/50; H04W 80/04; H04W 84/18

(52) U.S. Cl. CPC H04W 16/10; H04W 48/18; H04W 4/50; H04W 80/04; H04W 84/18

(57) ABSTRACT

A method includes causing a graphical user interface to be output by a display. The graphical user interface is a network service generation template having a first user input field configured to receive a first user input identifying a first parameter associated with a network service, a second user input field configured to receive a second user input identifying a second parameter associated with the network service, and a third user input field configured to receive a third user input identifying the second parameter as fixed or dynamic. The method also includes processing the first user input, the second user input and the third user input to generate a network service descriptor including the first parameter, the second parameter and the third parameter. The method further includes causing the network service descriptor to be stored in a database. The method additionally includes processing an instruction to deploy the network service.

### BACKGROUND

Network service providers and device manufacturers (e.g., wireless, cellular, etc.) are continually challenged to deliver value and convenience to consumers by, for example, providing compelling network services that are capable of being flexibly constructed, scalable and diverse.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a communication system for flexibly constructing a network service, in accordance with one or more embodiments.

FIG. 2 is a diagram of a graphical user interface for flexibly constructing a network service, in accordance with one or more embodiments.

FIG. 3 is a diagram of a method for flexibly constructing a network service, in accordance with one or more embodiments.

FIG. 4 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Network services are often provided by inflexible systems that are difficult to configure, scale, and deploy over various target areas.

Network functions virtualization (NFV) implements one or more network functions of a network appliance by way of software on a virtual machine (VM) which is caused to run on a virtualization layer such as a hypervisor on a server implemented by at least one processor. Sometimes, a virtualized network function (VNF) corresponds to an application that operates on a virtual machine (VM) provided on a server to implement a network function by software. Some conventional networking systems deploy functional units in accordance with a purchase of a network service, and involve deconstructing an order of a product purchased by a customer into VNF units and deploying the VNF units on a network functions virtualization infrastructure (NFVI). NFVI is an infrastructure configured to virtualize, using a virtualization layer such as a hypervisor, hardware resources of a physical machine (e.g., a server implemented by at least one processor) such as computing, storage and network functions, as virtualized hardware resources such as virtualized computing, virtualized storage, and virtualized network to allow flexible handling of various system resources.

Some conventional networking systems deploy a network functional unit to an available computing device according to a deployment request so as to implement a network function or network service. Other conventional networking systems allow multiple business operators to uniquely use all or a part of multiple network slices managed by a higher-level business operator.

Conventional networking systems, however, are not easily managed or capable of flexibly constructing networking services that are easily customizable, scalable and/or meet various diverse needs without significant reconfiguration and testing of one or more network elements.

To implement a network function, application or network service comprising one or more network functions, applications and/or network services, a system operator often creates a workflow for deploying the network function, application and/or network service. Such network functions, applications, and/or network services are sometimes associated with healing, scaling, configuring or upgrading a communication network or network device, or some other suitable function.

In some cases, communication networks involve numerous instances when deploying one or more network functions, applications and/or network services which, in turn, involves generating unique internet protocol (IP) addresses and/or unique names. This is a tedious task for network operators that sometimes results in creating custom scripts for each type of network function, application and/or network service that is to be deployed. For example, if there are one hundred such applications, a network operator has to create one hundred workflows, one for each application, because a conventional network orchestrator is hard coded for each workflow, including hardcoding which parameter of a network function or application has a dynamic value, and/or hardcoding IP access module (IPAM) end points, and/or hardcoding IP address values that are to be picked from an IPAM response.

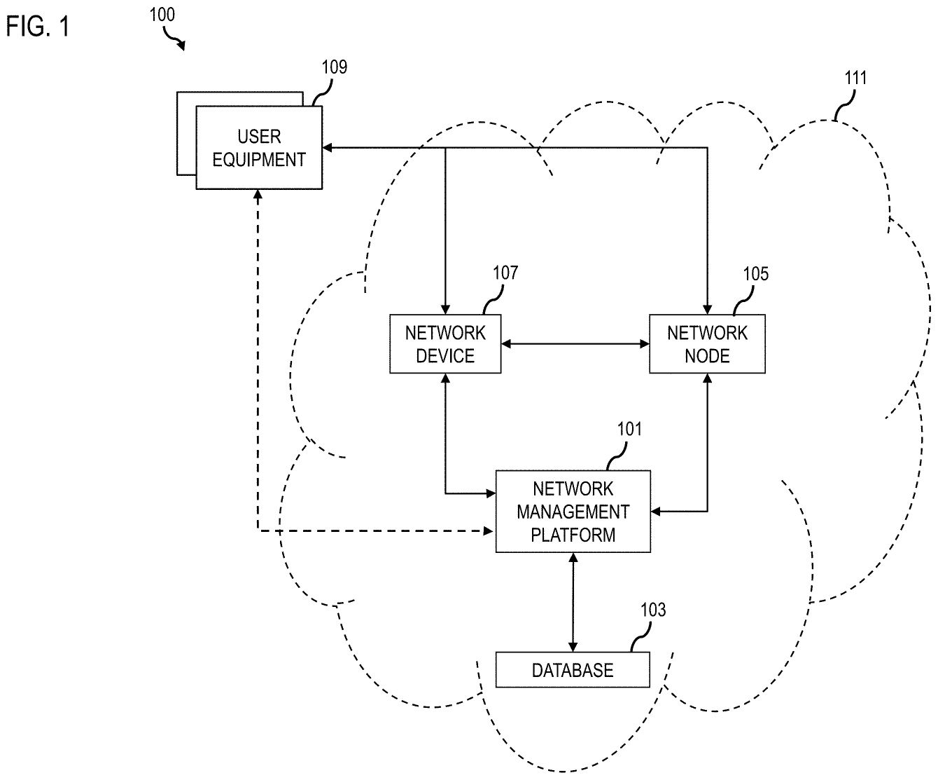

FIG. 1 is a diagram of a communication system 100 for flexibly constructing a network service, in accordance with one or more embodiments. In some embodiments, system 100 facilitates generating workflow templates and/or network service generation templates for constructing and/or deploying a network service associated with a communication network.

The system 100 makes it possible to implement one or more generic workflow/network service generation templates instead of having to hardcode custom workflows for each network function, application and/or network service that affects the performance, accessibility, configuration, scale, and/or deployment of a communication network, various network functions, network services, and the like.

In some embodiments, the system 100 provides the capability to define parameters as being static or dynamic for various network functions, applications and/or network services in the day-0 payload. For example, a network orchestrator then knows which application programming interface (API) call is to be made to which IPAM module, in the case that there are multiple IPAM modules and/or multiple network vendors that are involved or available for providing a network service.

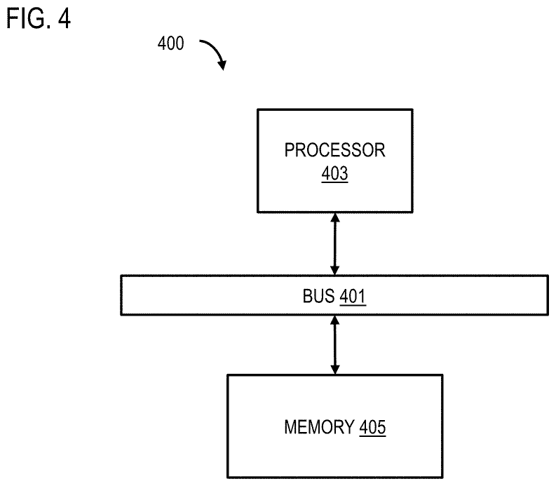

As shown in FIG. 1, system 100 comprises a network management platform 101, a database 103, one or more network nodes 105, one or more network devices 107, and one or more user equipment (UE) 109. The network management platform 101, the database 103, the one or more network nodes 105, the one or more network devices 107, and/or the one or more user equipment (UE) 109 are communicatively coupled by way of communication network 111. In some embodiments, various components of system 100 individually, or together, are implemented as a set of computer readable instructions that, when executed by a processor such as a processor 403 (FIG. 4), facilitates the processes discussed with respect to one or more embodiments. It is contemplated that the functions of these components may be combined in one or more components or performed by other components of equivalent functionality.

Network management platform 101 is configured to generate one or more workflows for constructing and/or deploying one or more network functions, applications or network services. In some embodiments, network management platform 101 receives data from one or more of the network node 105 or the network device 107 such as a radio station, a radio frequency (RF) emitter, or other suitable network component which is configured to communicate data to the network management platform 101 via a network protocol stack, corresponding protocol layer logs, or direct communication when identifying a current operating state of the network.

In some embodiments, network node 105 is an evolved node B (eNB) in fourth generation (4G), a fifth generation (5G) logical node (gNB), a new radio (NR) base station, or other suitable node. In some embodiments, network management platform 101 comprises a set of computer readable instructions that, when executed by a processor such as a processor 403 (FIG. 4), causes network management platform 101 to perform the processes discussed in accordance with one or more embodiments. In some embodiments, network management platform 101 is remote from the network node 105 and the network device 107. In some embodiments, network management platform 101 is a part of one or more of the network node 105 or the network device 107. In some embodiments, one or more processes the network management platform 101 is configured to perform is divided among one or more of the network node 105 or the network device 107 and a processor remote from the network node 105 and/or the network device 107. In some embodiments, the network management platform 101 is at least partially implemented by a UE 109.

In some embodiments, database 103 is a centralized network repository having searchable information stored therein that includes network functions, applications and/or network services capable of being implemented in the network. Database 103 is a memory such as a memory 405 (FIG. 4) capable of being queried or caused to store data in accordance with one or more embodiments.

In some embodiments, network management platform 101 generates a graphical user interface that is output to a display by way of a UE 109 or a terminal associated with network management platform 101 for a user (e.g., a network operator, a network vendor, and any personnel which would like to or is responsible to monitor and/or operate the network 111), so as to allow the user to input or select parameters for setting or configuring workflows for constructing and/or deploying a network function, application and/or network service. In some embodiments, network management platform 101 is a network orchestrator or an end-to-end orchestrator.

Network management platform 101 causes a graphical user interface to be output by a display of UE 109 that includes a network service generation template. The network service generation template comprises a first user input field configured to receive a first user input identifying a first parameter associated with a network service, a second user input field configured to receive a second user input identifying a second parameter associated with the network service, and a third user input field configured to receive a third user input identifying whether the second parameter is fixed or dynamic.

The network management platform 101 processes the first user input, the second user input and the third user input to generate a network service descriptor comprising the first parameter, the second parameter and the third parameter. The network management platform 101 then causes the network service descriptor to be stored in the database 103. In some embodiments, the database 103 is a service catalog of a network orchestrator.

In some embodiments, network management platform 101 processes an instruction to deploy the network service. Based on the instruction to deploy the network service, the network management platform searches the database 103 for the network service descriptor. Network management platform 101 then determines whether the second parameter included in the network service descriptor is fixed or dynamic and generates an initial network service instance by causing a parameter value module to generate a value for the second parameter according to the network service descriptor based on a determination that the second parameter included in the network service descriptor is dynamic. Subsequently, the network management platform 101 deploys the network service according to the initial network service instance. In some embodiments, the initial network service instance is considered as a day-0 configuration which is applied during an initial boot-up or instantiation of a network function, application and/or network service. A day-1 configuration is, for example, a configuration applied after the network function, application and/or network service is instantiated to provide the network function, application and/or network service.

In some embodiments, the network service is a virtualized radio access network, the first parameter is a name, the second parameter is an internet protocol address, and the parameter value module is an internet protocol address manager (IPAM). In some embodiments, the network service comprises a plurality of network functions. In some embodiments, the plurality of network functions comprises a central unit—control plane, a central unit—user plane, and a virtualized distributed unit.

In some embodiments, upon determining the first parameter included in the network service descriptor is dynamic, the network management platform causes a naming module parameter value module to generate the name for the initial network service instance according to the network service descriptor based on the determination that the first parameter included in the network service descriptor is dynamic.

In some embodiments, the network service generation template further comprises a fourth user input field configured to receive a fourth user input identifying whether the parameter value module is a single parameter module or one of an identifiable quantity of parameter value modules. The network management platform 101 processes the fourth user input to identify the single parameter value module or a corresponding one of the identifiable quantity of parameter value modules to generate the value for the second parameter according to the network service descriptor based on the determination that the second parameter included in the network service descriptor is dynamic and the fourth user input.

In some embodiments, the network service generation template further comprises a fifth user input field configured to receive a fifth user input identifying which of the identifiable quantity of parameter value modules is the corresponding one of the identifiable quantity of parameter value modules. The network management platform 101 then causes the corresponding one of the identifiable quantity of parameter value modules to generate the first or the second parameter values based on the fifth user input.

In some embodiments, the network management platform 101 processes the first user input, the second user input and the third user input to generate the network service descriptor by converting information associated with the first user input, the second user input and the third user input to computer readable code. A portion of the computer readable code caused to be generated by the network management platform 101 comprises at least one marker identifying which portion of the computer readable code is associated with the dynamic second parameter. In some embodiments, the marker comprises double brackets or some other suitable formatting that sets apart the second parameter from other computer readable code indicating that the portion of the computer readable code within the marker is dynamic. For example, computer readable code associated with a day-0 schema for an IPAM may be “{{ROS.IPAM.nfinstance1.Data.IPaddress}},” where ROS indicates a parent group name or company name that IPAM belongs to, IPAM.nfinstance1 indicates a module name (i.e., IPAM or naming module), Data indicates the template name in the IPAM, and IPaddress is a determinable or fillable value based on a response from the IPAM. As another example, computer readable code associated with a day-0 schema for a naming module may be “{{RCP.NAMING.CUCP_NF_Template}},” where RCP indicates a parent group name or company name that the NAMING module belongs to, NAMING indicates a module name (i.e., IPAM or naming module), CUCP_NF_Template indicates the template name in the Naming module, and the name is a determinable or fillable value based on a response from the naming module.

The network management platform 101 then causes the network service descriptor comprising the marker to be stored in the database 103 as computer readable code.

In some embodiments, the computer readable code including the marker is based on a response from a parameter value module that is in a JavaScript object notation (JSON) format for which the dynamic portion in the computer readable code is to be input based on the network service being constructed and/or deployed.

In some embodiments, the network service is configured to one or more of cause the network 111 to be healed, updated, or scaled based on the initial network service instance being deployed to a server cluster associated with the communication network. In some embodiments, a network function or application included in the network service is a database application and a webserver application, wherein the network service is a combining of the database application and the webserver. In some embodiments, the network service is a voice communication service, a data communication service, or the like that is provided to a purchaser who is a mobile virtual network operator (MVNO). The voice communication service or the data communication service provided will be eventually provided to a customer/end user for the purchaser, by way of a UE 109 that may be the same as UE 109 discussed above, or some other UE 109 that is capable of accessing the network for using the network service.

In some embodiments, a virtual distributed unit (vDU) and a virtual centralized unit (vCU), which are components of a radio access network (RAN) in 4G, are network functions associated with a base station of network 111 and/or with in another part of network 111. In some embodiments, a DU and a CU, which are components of the RAN in 5G, are network functions associated with a base station of network 111 and/or incorporated in another part of network 111.

The network service provided is not limited to a voice communication service and a data communication service. In some embodiments, the network service provided is an IoT service. In some embodiments, a customer/end user who uses a robot arm, a connected car, or the like may be a purchaser of the network service. In some embodiments, the UE 109 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, the UE 109 comprises a display by which the discussed graphical user interface, or some other suitable graphical user interface is displayed.

In some embodiments, the network service generation template comprises service catalog data corresponding to a part of technology section data included in a bundle file associated with one or more network functions or applications included in the network service. In some embodiments, the service catalog data comprises one or more workflow scripts for building the network service.

Based on the combination of inputs received by way of graphical user interface a network service is capable of being constructed by way of minimal user input which may be limited to filling in fixed values or static information, designating parameters as being static or dynamic, and relying on the network management platform 101 to fill in the requisite parameter information on demand when the network service descriptor is generated, when the network service is deployed, or at some other suitable time.

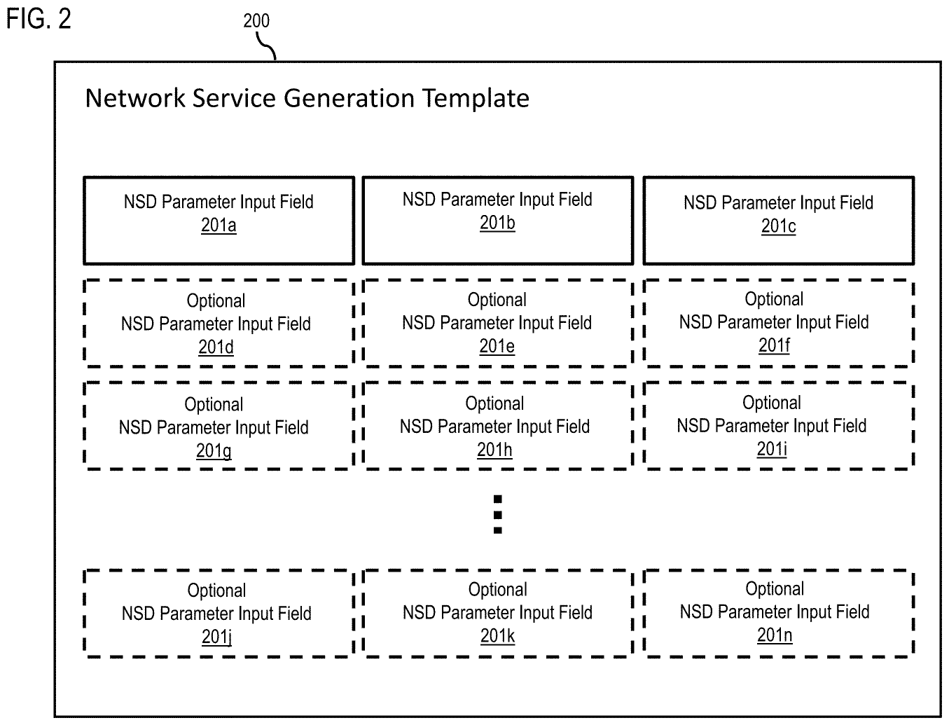

FIG. 2 is a diagram of a graphical user interface 200 for flexibly constructing a network service, in accordance with one or more embodiments. Network management platform 101 (FIG. 1) is configured to cause graphical user interface 200 to be output to a display, for example, of UE 109 (FIG. 1). Graphical user interface 200 comprises a network service descriptor (NSD) parameter input field 201a configured to receive a first user input identifying a NSD name, a NSD parameter input field 201b configured to receive a second user input identifying an IP address, and a NSD parameter input field 201c configured to receive a third user input identifying whether the parameter in NSD parameter input field 201b is fixed or dynamic.

In some embodiments, the NSD parameter input field 201a is configured to receive a first user input identifying some other suitable parameter, the NSD parameter input field 201b configured to receive a second user input identifying a name, and NSD parameter input field 201c configured to receive a third user input identifying whether the parameter in NSD parameter input field 201b is fixed or dynamic.

Graphical user interface 200 comprises various combinations of NSD parameter input fields 201a-201n (collectively referred to as “parameter input field 201”) that are each configured to receive a user input identifying some parameter and one or more of the NSD parameter input fields is configured to receive a user input identifying whether a parameter in a different NSD parameter input field 201 corresponding to another one of the NSD parameter input fields is fixed or dynamic. For example, if one of the NSD parameter input fields 201 is associated with a name, and another one of the NSD parameter input fields 201 is associated with an IP address, graphical user interface 200, in some embodiments, includes two NSD parameter input fields 201 that are in a one-to-one correspondence with the name and IP address parameter input fields 201 so that each of the name and IP address parameter input fields 201 are capable of being identified as fixed or dynamic based on a user input.

In some embodiments, one of the optional user input fields 201 is configured to receive a fourth user input identifying whether a parameter value module is a single parameter module or one of an identifiable quantity of parameter value modules. For example, if a name or an IP address is identified as being dynamic, then the network management platform 101 causes a naming module or an IPAM to generate a name or an IP address for the network service that is being generated based on the inputs made into graphical user interface 200. If, for example, there are multiple available parameter value modules, one or more of the available parameter value modules is capable of being selected to generate a value for a corresponding dynamic parameter. In some embodiments, if there are multiple parameter value modules, for example, multiple available IPAMS or naming managers, graphical user interface 200 is configured to receive a fifth user input identifying which of the identifiable quantity of parameter value modules is the corresponding one of the identifiable quantity of parameter value modules. In some embodiments, the fifth user input is received by way of a user input field 201 within a user input field that includes a series of selectable parameter value modules, a pop-up window that includes a series of selectable parameter value modules, another user input field 201 that is caused to appear within the same display of graphical user interface 200 that includes a series of selectable parameter value modules, or another user input field 201 that is caused to appear on a different screen or display of graphical user interface 200 that includes a series of selectable parameter value modules. Network management platform 101 is then configured to cause a corresponding one of the identifiable quantity of parameter value modules to generate the first or the second parameter values based on the fifth user input.

In some embodiments, the graphical user interface 200 comprises one or more optional user interface fields 201 configured to receive one or more additional user inputs for designating one or more additional parameters associated with constructing and/or deploying a network service. In some embodiments, one or more of the NSD parameter input fields is configured to receive a user input identifying version, a domain, a class, a vendor, a sequence number, a day-0 or a day-1 or other day-number designator, network function name, network function description, network function version, network function bundle reference, a key cloak configuration, an OBF configuration, a CMaaS configuration, a category tagging a type of a generated network service, a description of the network service or network function, or some other suitable detail regarding the naming, tracking, implementation, construction, instantiation, etc. of a network service, network function or application.

The user can manually input the parameters into the user input fields (e.g., via keyboard, voice control, and the like). Alternatively, the user input fields can provide (in the form of a drop-down list, pop-out window, or some other suitable options) available parameters or parameters suggested by the network management platform 101 based on other inputted/selected parameters, and the user can simply select the available parameters from the drop-down list, pop-out window, slider, radio button, or other suitable options. On the other hand, the user can simply input a keyword(s) into the user input fields, and the user input fields will then provide a drop-down list comprises available and/or suggested parameters associated with the keyword(s).

Network management platform 101 processes the parameters input by way of graphical user interface to construct and/or deploy a network service according to the parameters that are input.

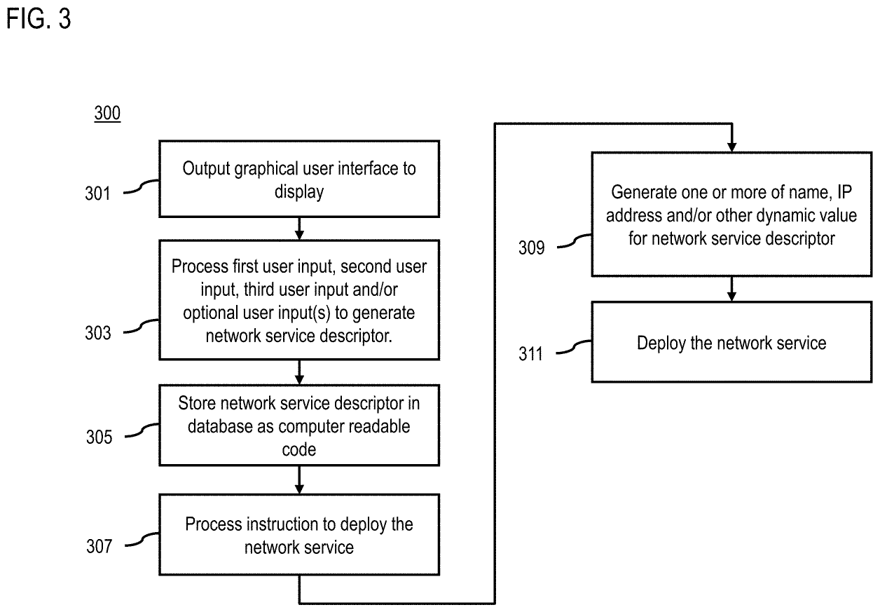

FIG. 3 is a flowchart of a process 300 for flexibly constructing a network service, in accordance with one or more embodiments. In some embodiments, the network management platform 101 (FIG. 1) performs the process 300.

In step 301, a graphical user interface is caused to be output by a display. The graphical user interface includes a network service generation template comprising a first user input field configured to receive a first user input identifying a first parameter associated with a network service, a second user input field configured to receive a second user input identifying a second parameter associated with the network service, and a third user input field configured to receive a third user input identifying whether the second parameter is fixed or dynamic.

In some embodiments, the network service is a virtualized radio access network, the first parameter is a name, the second parameter is an internet protocol address, and the parameter value module is an internet protocol address manager. In some embodiments, the network service comprises a plurality of network functions. In some embodiments, the plurality of network functions comprises a central unit—control plane, a central unit—user plane, and a virtualized distributed unit.

In step 303, the first user input, the second user input and the third user input are processed to generate a network service descriptor comprising the first parameter, the second parameter and the third parameter.

In some embodiments, the network service generation template optionally comprises a fourth user input field configured to receive a fourth user input identifying whether the parameter value module is a single parameter module or one of an identifiable quantity of parameter value modules. The optional fourth user input is then processed to identify the single parameter value module or a corresponding one of the identifiable quantity of parameter value modules to generate the value for the second parameter according to the network service descriptor based on the determination that the second parameter included in the network service descriptor is dynamic and the fourth user input.

In some embodiments, the network service generation template optionally comprises a fifth user input field configured to receive a fifth user input identifying which of the identifiable quantity of parameter value modules is the corresponding one of the identifiable quantity of parameter value modules. The corresponding one of the identifiable quantity of parameter value modules is then caused to generate the first or the second parameter values based on the fifth user input.

In some embodiments, processing the first user input, the second user input and the third user input to generate the network service descriptor comprises converting information associated with the first user input, the second user input and the third user input to computer readable code. A portion of the computer readable code comprises at least one marker identifying the portion of the computer readable code is associated with the dynamic second parameter.

In step 305, the network service descriptor is caused to be stored in a database. In some embodiments, the database is a service catalog of a network orchestrator. In some embodiments, the network service descriptor comprising the marker is stored in the database as the computer readable code.

In step 307 an instruction to deploy the network service is processed, and the database is searched for the network service descriptor based on the instruction to deploy the network service.

In step 309, based on a determination that the second parameter included in the network service descriptor is dynamic, an initial network service instance is generated by causing a parameter value module to generate a value for the second parameter according to the network service descriptor. In some embodiments, based on a determination that the first parameter included in the network service descriptor is dynamic, a naming module is caused to generate the name for the initial network service instance according to the network service descriptor. In some embodiments, an IPAM is caused to provide an IP address, or some other appropriate module is caused to generate a corresponding value for a parameter identified as being dynamic.

In step 311, the network service is deployed according to the initial network service instance. In some embodiments, the network service is configured to one or more of cause a communication network to be healed, updated, or scaled based on the initial network service instance being deployed to a server cluster associated with the communication network.

In some embodiments, the discussed systems, graphical user interfaces and/or processed herein make it possible for a network orchestrator to have a generic workflow for multiple applications and/or network functions, identify which parameters in a network service template are static or dynamic and are to be generated by an appropriate module such as a naming module, IPAM or some other suitable module, identify which of the IPAM, the naming module, and/or other suitable module is to be called in the case of there being multiple modules, generate the IP address, application name, etc., by making calls to the appropriate IPAM, naming module and/or other suitable module, fill a complete day-0 payload with generated parameters as-needed according to the parameters included in the template and deploy the network service without needed to hard code each individual parameter associated with the instance of the network service.

FIG. 4 is a functional block diagram of a computer or processor-based system 400 upon which or by which an embodiment is implemented.

Processor-based system 400 is programmed to flexibly construct a network service, as described herein, and includes, for example, bus 401, processor 403, and memory 405 components.

In some embodiments, the processor-based system is implemented as a single “system on a chip.” Processor-based system 400, or a portion thereof, constitutes a mechanism for performing one or more steps of flexibly constructing a network service.

In some embodiments, the processor-based system 400 includes a communication mechanism such as bus 401 for transferring information and/or instructions among the components of the processor-based system 400. Processor 403 is connected to the bus 401 to obtain instructions for execution and process information stored in, for example, the memory 405. In some embodiments, the processor 403 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 403. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 403 performs a set of operations on information as specified by a set of instructions stored in memory 405 related to flexibly constructing a network service. The execution of the instructions causes the processor to perform specified functions.

The processor 403 and accompanying components are connected to the memory 405 via the bus 401. The memory 405 includes one or more of dynamic memory (e.g., RAM, magnetic disk, writable optical disk, etc.) and static memory (e.g., ROM, CD-ROM, etc.) for storing executable instructions that when executed perform the steps described herein to flexibly constructing a network service. The memory 405 also stores the data associated with or generated by the execution of the steps.

In one or more embodiments, the memory 405, such as a random access memory (RAM) or any other dynamic storage device, stores information including processor instructions for flexibly constructing a network service. Dynamic memory allows information stored therein to be changed. RAM allows a unit of information stored at a location called a memory address to be stored and retrieved independently of information at neighboring addresses. The memory 405 is also used by the processor 403 to store temporary values during execution of processor instructions. In various embodiments, the memory 405 is a read only memory (ROM) or any other static storage device coupled to the bus 401 for storing static information, including instructions, that is not capable of being changed by processor 403. Some memory is composed of volatile storage that loses the information stored thereon when power is lost. In some embodiments, the memory 405 is a non-volatile (persistent) storage device, such as a magnetic disk, optical disk or flash card, for storing information, including instructions, that persists even when the system 400 is turned off or otherwise loses power.

The term “computer-readable medium” as used herein refers to any medium that participates in providing information to processor 403, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is directed to a method comprising causing, by a processor, a graphical user interface to be output by a display. The graphical user interface is a network service generation template comprising: a first user input field configured to receive a first user input identifying a first parameter associated with a network service; a second user input field configured to receive a second user input identifying a second parameter associated with the network service; and a third user input field configured to receive a third user input identifying whether the second parameter is fixed or dynamic. The method also comprises processing the first user input, the second user input and the third user input to generate a network service descriptor comprising the first parameter, the second parameter and the third parameter. The method further comprises causing the network service descriptor to be stored in a database. The method additionally comprises processing an instruction to deploy the network service. The method also comprises searching the database for the network service descriptor based on the instruction to deploy the network service. The method further comprises determining whether the second parameter included in the network service descriptor is fixed or dynamic. The method additionally comprises generating an initial network service instance by causing a parameter value module to generate a value for the second parameter according to the network service descriptor based on a determination that the second parameter included in the network service descriptor is dynamic. The method also comprises deploying the network service according to the initial network service instance.

Another aspect of this description is directed to an apparatus comprising a processor and a memory having instructions stored thereon that, when executed by the processor, cause the apparatus to cause a graphical user interface to be output by a display. The graphical user interface is a network service generation template comprising: a first user input field configured to receive a first user input identifying a first parameter associated with a network service; a second user input field configured to receive a second user input identifying a second parameter associated with the network service; and a third user input field configured to receive a third user input identifying whether the second parameter is fixed or dynamic. The apparatus is also caused to process the first user input, the second user input and the third user input to generate a network service descriptor comprising the first parameter, the second parameter and the third parameter. The apparatus is further caused to cause the network service descriptor to be stored in a database. The apparatus is additionally caused to process an instruction to deploy the network service. The apparatus is also caused to search the database for the network service descriptor based on the instruction to deploy the network service. The apparatus is further caused to determine whether the second parameter included in the network service descriptor is fixed or dynamic. The apparatus is additionally caused to generate an initial network service instance by causing a parameter value module to generate a value for the second parameter according to the network service descriptor based on a determination that the second parameter included in the network service descriptor is dynamic. The apparatus is also caused to deploy the network service according to the initial network service instance.

Another aspect of this description is directed to a non-transitory computer readable medium having instructions stored thereon that, when executed by a processor, cause an apparatus to cause a graphical user interface to be output by a display. The graphical user interface is a network service generation template comprising: a first user input field configured to receive a first user input identifying a first parameter associated with a network service; a second user input field configured to receive a second user input identifying a second parameter associated with the network service; and a third user input field configured to receive a third user input identifying whether the second parameter is fixed or dynamic. The apparatus is also caused to process the first user input, the second user input and the third user input to generate a network service descriptor comprising the first parameter, the second parameter and the third parameter. The apparatus is further caused to cause the network service descriptor to be stored in a database. The apparatus is additionally caused to process an instruction to deploy the network service. The apparatus is also caused to search the database for the network service descriptor based on the instruction to deploy the network service. The apparatus is further caused to determine whether the second parameter included in the network service descriptor is fixed or dynamic. The apparatus is additionally caused to generate an initial network service instance by causing a parameter value module to generate a value for the second parameter according to the network service descriptor based on a determination that the second parameter included in the network service descriptor is dynamic. The apparatus is also caused to deploy the network service according to the initial network service instance.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
causing, by a processor, a graphical user interface to be output by a display, the graphical user interface being a network service generation template comprising:
a first user input field configured to receive a first user input identifying a first parameter associated with a network service;
a second user input field configured to receive a second user input identifying a second parameter associated with the network service; and
a third user input field configured to receive a third user input identifying whether the second parameter is fixed or dynamic;
processing the first user input, the second user input and the third user input to generate a network service descriptor comprising the first parameter, the second parameter and the third parameter;
causing the network service descriptor to be stored in a database;
processing an instruction to deploy the network service;
searching the database for the network service descriptor based on the instruction to deploy the network service;
determining whether the second parameter included in the network service descriptor is fixed or dynamic;
generating an initial network service instance by causing a parameter value module to generate a value for the second parameter according to the network service descriptor based on a determination that the second parameter included in the network service descriptor is dynamic; and
deploying the network service according to the initial network service instance.

2. The method of claim 1, wherein the network service is a virtualized radio access network, the first parameter is a name, the second parameter is an internet protocol address, and the parameter value module is an internet protocol address manager.

3. The method of claim 2, wherein the network service comprises a plurality of network functions.

4. The method of claim 3, wherein the plurality of network functions comprises a central unit—control plane, a central unit—user plane, and a virtualized distributed unit.

5. The method of claim 2, further comprising:
determining whether the first parameter included in the network service descriptor is fixed or dynamic; and
causing a naming module parameter value module to generate the name for the initial network service instance according to the network service descriptor based on a determination that the first parameter included in the network service descriptor is dynamic.

6. The method of claim 1, wherein the database is a service catalog of a network orchestrator.

7. The method of claim 1, wherein the network service generation template further comprises a fourth user input field configured to receive a fourth user input identifying whether the parameter value module is a single parameter module or one of an identifiable quantity of parameter value modules.

8. The method of claim 7, further comprising:
processing the fourth user input to identify the single parameter value module or a corresponding one of the identifiable quantity of parameter value modules to generate the value for the second parameter according to the network service descriptor based on the determination that the second parameter included in the network service descriptor is dynamic and the fourth user input.

9. The method of claim 7, wherein the network service generation template further comprises a fifth user input field configured to receive a fifth user input identifying which of the identifiable quantity of parameter value modules is the corresponding one of the identifiable quantity of parameter value modules, and the method further comprises:
causing the corresponding one of the identifiable quantity of parameter value modules to generate the first or the second parameter values based on the fifth user input.

10. The method of claim 1, wherein processing the first user input, the second user input and the third user input to generate the network service descriptor comprises:
converting information associated with the first user input, the second user input and the third user input to computer readable code,
wherein
a portion of the computer readable code comprises at least one marker identifying the portion of the computer readable code is associated with the dynamic second parameter, and
the network service descriptor comprising the marker is stored in the database as the computer readable code.

11. The method of claim 1, wherein the network service is configured to one or more of cause a communication network to be healed, updated, or scaled based on the initial network service instance being deployed to a server cluster associated with the communication network.

12. An apparatus comprising:
a processor; and
a memory having instructions stored thereon that, when executed by the processor, cause the apparatus to:
cause a graphical user interface to be output by a display, the graphical user interface being a network service generation template comprising:
a first user input field configured to receive a first user input identifying a first parameter associated with a network service;
a second user input field configured to receive a second user input identifying a second parameter associated with the network service; and
a third user input field configured to receive a third user input identifying whether the second parameter is fixed or dynamic;
process the first user input, the second user input and the third user input to generate a network service descriptor comprising the first parameter, the second parameter and the third parameter;
cause the network service descriptor to be stored in a database;
process an instruction to deploy the network service;
search the database for the network service descriptor based on the instruction to deploy the network service;
determine whether the second parameter included in the network service descriptor is fixed or dynamic;
generate an initial network service instance by causing a parameter value module to generate a value for the second parameter according to the network service descriptor based on a determination that the second parameter included in the network service descriptor is dynamic; and
deploy the network service according to the initial network service instance.

13. The apparatus of claim 12, wherein the network service is a virtualized radio access network, the first parameter is a name, the second parameter is an internet protocol address, and the parameter value module is an internet protocol address manager.

14. The apparatus of claim 13, wherein the network service comprises a plurality of network functions.

15. The apparatus of claim 14, wherein the plurality of network functions comprises a central unit—control plane, a central unit—user plane, and a virtualized distributed unit.

16. The apparatus of claim 13, wherein the apparatus is further caused to:
determine whether the first parameter included in the network service descriptor is fixed or dynamic; and
cause a naming module parameter value module to generate the name for the initial network service instance according to the network service descriptor based on a determination that the first parameter included in the network service descriptor is dynamic.

17. The apparatus of claim 12, wherein the database is a service catalog of a network orchestrator.

18. The apparatus of claim 12, wherein the network service generation template further comprises a fourth user input field configured to receive a fourth user input identifying whether the parameter value module is a single parameter module or one of an identifiable quantity of parameter value modules.

19. The apparatus of claim 18, wherein the apparatus is further caused to:
process the fourth user input to identify the single parameter value module or a corresponding one of the identifiable quantity of parameter value modules to generate the value for the second parameter according to the network service descriptor based on the determination that the second parameter included in the network service descriptor is dynamic and the fourth user input.

20. A non-transitory computer readable memory having instructions stored thereon that, when executed by a processor, cause an apparatus to:
cause a graphical user interface to be output by a display, the graphical user interface being a network service generation template comprising:
a first user input field configured to receive a first user input identifying a first parameter associated with a network service;
a second user input field configured to receive a second user input identifying a second parameter associated with the network service; and
a third user input field configured to receive a third user input identifying whether the second parameter is fixed or dynamic;
process the first user input, the second user input and the third user input to generate a network service descriptor comprising the first parameter, the second parameter and the third parameter;
cause the network service descriptor to be stored in a database;
process an instruction to deploy the network service;
search the database for the network service descriptor based on the instruction to deploy the network service;
determine whether the second parameter included in the network service descriptor is fixed or dynamic;
generate an initial network service instance by causing a parameter value module to generate a value for the second parameter according to the network service descriptor based on a determination that the second parameter included in the network service descriptor is dynamic; and
deploy the network service according to the initial network service instance.
